(19) United States
(12) Patent Application Publication
(10) Pub. No.: US 2022/0268393 A1
(43) Pub. Date: Aug. 25, 2022

(54) Pipeline Inspection Device

(71) Applicant: Kakivik Asset Management, LLC, Anchorage, AK (US)

(72) Inventors: Ian Moreau, Eagle River, AK (US); Zhenhua Sun, Anchorage, AK (US)

(73) Assignee: Kakivik Asset Management, LLC, Anchorage, AK (US)

(21) Appl. No.: 17/575,146

(22) Filed: Jan. 13, 2022

Related U.S. Application Data
(63) Continuation-in-part of application No. 17/459,427, filed on Aug. 27, 2021.
Application No. 17/459,427 is a continuation of application No. 17/181,396, filed on Feb. 22, 2021, now Pat. No. 11,118,719.
Application No. 17/459,427 is a continuation of application No. 17/182,396, filed on Feb. 23, 2021.

(51) Int. Cl. F16L 55/32; F16L 101/30

(52) U.S. Cl. CPC F16L 55/32; F16L 2101/30

(57) ABSTRACT

A device to inspect a pipeline includes a device housing movable relative to the pipeline, a radiation device, and an imaging device. The radiation device is coupled to the device housing and disposed adjacent to the pipeline. The imaging device is coupled to the device housing and disposed adjacent to the pipeline. The imaging device is disposed opposite to the radiation device relative to the pipeline. The imaging device receives radiation from the radiation device to provide an imaging signal. Because the radiation device and the imaging device are disposed opposite to each other relative to the pipeline, the pipeline inspection device can provide an enhanced image in a single pass of the pipeline.

### REFERENCE TO RELATED APPLICATIONS

The application is a continuation-in-part of U.S. patent application Ser. No. 17/459,427 filed on Aug. 27, 2021, which is a continuation of U.S. patent application Ser. No. 17/181,396, filed on Feb. 22, 2021, now U.S. Pat. No. 11,118,719, the entirety of each of which is incorporated herein by reference.

### TECHNICAL FIELD

The present disclosure relates generally to robotic inspection devices, and more particularly, to robotic inspection devices for pipeline inspections.

### BACKGROUND

Pipelines are used around the world to transport fluids for a multitude of applications including refineries and power plants. In some applications, pipelines transport oil or other liquids long distances in remote locations.

Pipelines may be damaged during installation or during the course of use. For example, pipelines can develop cracks, corrosion, erosion, and/or other defects. Defects and/or deterioration of the pipeline over time can lead to the failure of the pipeline. The failure of the pipeline can cause not only a loss of the transported fluid but also injury to persons and the environment. Thus, the integrity of pipelines can be periodically checked to avoid failures.

Damage to the pipeline can include internal damage, external damage not visible to the naked eye, and/or damage obscured by a covering or insulating layer disposed over the pipe. As can be appreciated, certain types of damage to the pipeline may be difficult to detect using visual inspection methods and devices.

Therefore, in some applications, pipelines are physically inspected to find damage that may not be detected using visual inspection methods. Physical inspection methods require physical access to the exterior and/or interior of the pipe and can require that the insulating layer of the pipeline is removed. As a result, physical inspection methods can be time consuming, require high levels of human intervention, and require repair of the insulating layer after inspection.

Therefore, what is needed is an apparatus, system or method that addresses one or more of the foregoing issues, among one or more other issues.

### SUMMARY OF THE INVENTION

A device to inspect a pipeline includes a device housing movable relative to the pipeline, a radiation device, and an imaging device. The radiation device is coupled to the device housing and disposed adjacent to the pipeline. The imaging device is coupled to the device housing and disposed adjacent to the pipeline. The imaging device is disposed opposite to the radiation device relative to the pipeline. The imaging device receives radiation from the radiation device to provide an imaging signal. Because the radiation device and the imaging device are disposed opposite to each other relative to the pipeline, the pipeline inspection device can provide an enhanced image in a single pass of the pipeline.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates a perspective view of a pipeline inspection device according to certain aspects of the present disclosure.

FIG. 2 illustrates a side elevation view of the pipeline inspection device of FIG. 1 disposed on a pipeline.

FIG. 3 illustrates a front elevation view of the pipeline inspection device of FIG. 1 disposed on a pipeline.

FIG. 4 illustrates a graphical user interface for use with the pipeline inspection device according to certain aspects of the present disclosure.

FIG. 5 illustrates a front elevation view of a pipeline inspection device according to certain aspects of the present disclosure.

FIG. 6 illustrates an example of a pipeline image.

### DETAILED DESCRIPTION

The present disclosure describes embodiments of a pipeline inspection device and methods of use thereof. As described herein, embodiments of the pipeline inspection device and methods of use thereof described herein address the issues described with respect to traditional pipeline inspection devices and methods.

A pipeline inspection device, such as a pipeline inspection robot or pipeline inspection crawler can be used to inspect a pipeline for damage. As described herein, a pipeline inspection device can detect damage that may not be detected from a visible inspection. Further, a pipeline inspection device may require less time and human intervention to inspect the pipeline.

However, traditional pipeline inspection devices may not reliably remain centered on a pipe as the device advances along the pipe. Further, traditional pipeline inspection devices may not reliably navigate around corners or turns of the pipeline. Accordingly, traditional pipeline inspection devices may require personnel to manually intervene to re-center or otherwise re-orientate the device on the pipeline, interrupting the pipeline inspection process.

Additionally, traditional pipeline inspection devices may not provide images of the pipeline that are detailed enough to allow operators to make informed decisions whether repairs are required at an area of interest for the pipeline. In some applications, traditional pipeline inspection devices may require personnel to manually inspect the pipe at the area of interest to determine if repairs are needed. During the manual inspection, the personnel may remove the insulating layer in the surrounding area to manually inspect the pipe at the area of interest.

Therefore, it is desired to provide a pipeline inspection device that can remain reliably centered on the pipeline during the inspection process. Further, it is desired to provide a pipeline inspection device that can reliably navigate corners or turns of the pipeline whilst still inspecting the pipe. Additionally, it is desired to provide a pipeline inspection device that can provide sufficient information to an operator to determine if repairs are needed on the pipeline.

As described herein, embodiments of the pipeline inspection device can include independently operated wheels to allow the pipeline inspection device to remain reliably centered on the pipeline and to reliably navigate corners or turns of the pipeline without human intervention. Further, embodiments of the pipeline inspection device can include an imaging device and processor to allow for increased levels of image detail compared to traditional pipeline inspection devices and to allow for automatic recognition of damaged portions of the pipeline without requiring manual inspections.

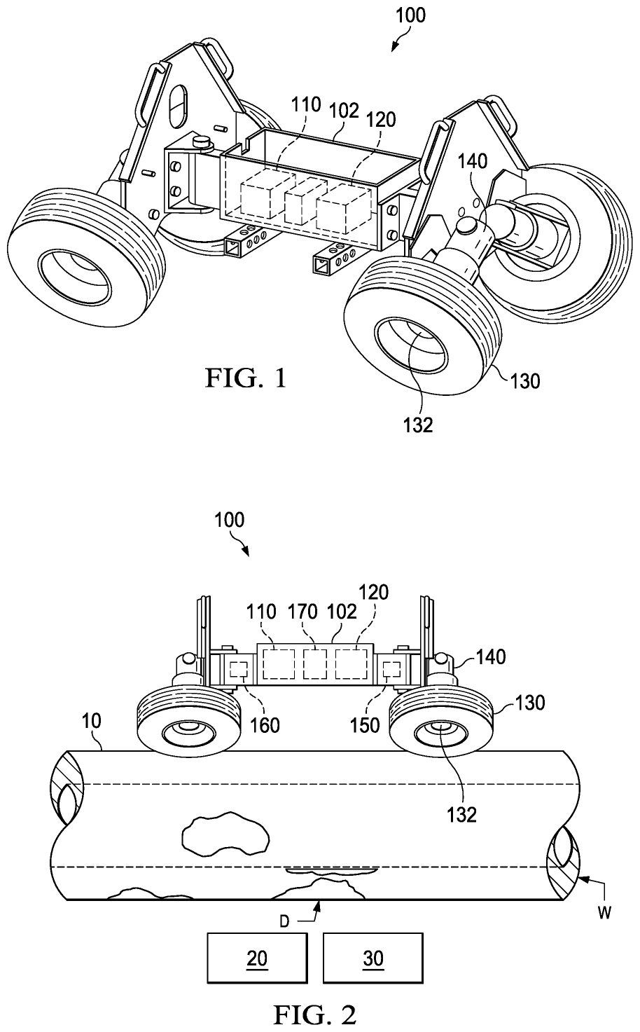

FIG. 1 illustrates a perspective view of a pipeline inspection device 100 according to certain aspects of the present disclosure. FIG. 2 illustrates a side elevation view of the pipeline inspection device 100 of FIG. 1 disposed on a pipeline 10. With reference to FIGS. 1 and 2, in the depicted example, a pipeline inspection device 100 can inspect a pipeline 10 with minimal human intervention. The pipeline inspection device 100 can include an imaging device 110 and a controller 120 disposed within a device housing 102. The device housing 102 can be moved along the pipeline 10 to allow the imaging device 110 to capture images along the pipeline 10.

The pipeline inspection device 100 includes a plurality of wheels 130 coupled to the device housing 102 to allow the pipeline inspection device 100 to move relative to the pipeline 10. The wheels 130 can extend away from the device housing 102. In some embodiments, the pipeline inspection device 100 includes four wheels 130. Optionally, the pipeline inspection device 100 can utilize wheels, sliders, treads, or other suitable features to allow the device housing 102 to the pipeline inspection device 100 to move relative to the pipeline 10. The wheels 130 or other features of the pipeline inspection device 100 can allow the pipeline inspection device 100 to travel along the pipeline 10 and over support saddles, other structures, and/or imperfections without stopping or interrupting the inspection operations of the pipeline inspection device 100 described herein.

In some embodiments, each of the wheels 130 can be independently driven, rotated, or otherwise controlled. For example, each wheel 130 can be driven by an independent motor 140 rotatably coupled to the wheel 130. An axle 132 extending from the motor 140 can couple a wheel 130 to a respective motor 140.

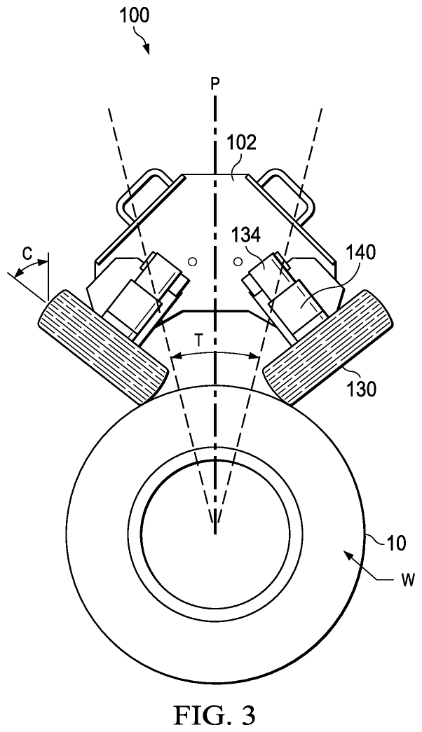

FIG. 3 illustrates a front elevation view of the pipeline inspection device 100 of FIG. 1 disposed on a pipeline 10. With reference to FIGS. 1-3, the pipeline inspection device 100 can be used to inspect pipelines 10 including pipes of various diameters. The camber angle C of the wheels 130 can be adjusted relative to the device housing 102 to allow the wheels 130 of the pipeline inspection device 100 to securely contact or engage with the surface of pipes of varying diameters. In some embodiments, the axle 132 connecting the wheel 130 to the motor 140 can include a swivel joint 134 to allow the wheel 130 to be disposed at a desired camber angle C relative to the device housing 102 as the wheel 130 is rotated. As can be appreciated, each axle 132 can include a similar swivel joint 134.

During operation, the motors 140 can be operated to advance the pipeline inspection device 100 relative to the pipeline 10, allowing inspection of the pipeline 10 as the pipeline inspection device 100 is in motion. The speed of the pipeline inspection device 100 can be adjusted to suit the conditions of the pipeline 10 and/or the parameters of the inspection. As described herein, the pipeline inspection device 100 can be remotely operated by an operator. The pipeline inspection device 100 can be remotely controlled by a tethered device or a wirelessly connected device.

In the depicted example, a controller 120 disposed within the device housing 102 can control the operation of the wheels 130 to control the position and advancement of the pipeline inspection device 100 relative to the pipeline 10. During operation, each motor 140 of the pipeline inspection device 100 can be independently controlled by the controller 120 to cooperatively advance and align the pipeline inspection device 100 relative to the pipeline 10. In some embodiments, the controller 120 can independently operate each motor 140 at a desired speed and direction to advance and align the pipeline inspection device 100. As can be appreciated, each motor 140 can be operated at a different speed and/or direction to provide a desired operation of the pipeline inspection device 100.

Optionally, the controller 120 can utilize signals from inertial measurement units (IMUs) 150 to calculate or determine the intended speed and direction of each motor 140. The pipeline inspection device 100 can include multiple IMUs 150 within the device housing 102 to robustly determine the orientation of the pipeline inspection device 100 relative to the pipeline. In some embodiments, the pipeline inspection device 100 includes a single IMU 150 associated with the device, an IMU 150 associated with each axle 132 of the pipeline inspection device 100, or an IMU 150 associated with each wheel 130 of the pipeline inspection device 100. The IMUs 150 can include various sensors, including, but not limited to gyroscopic sensors, accelerometers, magnetometers (e.g., triaxial magnetometers), etc. In the depicted example, the data from the IMU 150 can allow the controller 120 to determine the speed of the pipeline inspection device 100, the heading of the pipeline inspection device 100, and other parameters related to the status of the pipeline inspection device 100. The pipeline inspection device 100 can further include other sensors, such as wheel speed encoders to provide additional data to the controller 120. Advantageously, sensors such as the IMU 150 and the wheel speed sensors can allow the controller 120 to detect outside interference or changes in parameters, including wheel slip, wind, uneven pipe surfaces, etc.

The configuration or programming of the controller 120 can allow for the pipeline inspection device 100 to navigate turns, elbows, or bends along the pipeline 10. In the depicted example, the controller 120 can interpret input (such as start, stop, forward, and/or back commands) from an operator and utilize one or more algorithms to control the operation of the pipeline inspection device 100. In some applications, the controller 120 can verify operation parameters via feedback from IMUs 150, wheel speed sensors, and/or sub-routines that allows for self-correction of the motion of the pipeline inspection device 100. For example, the controller 120 may receive a start (forward or backward) command from an operator to initiate travel or motion of the inspection device and then utilize feedback from the IMUs 150 and/or control algorithms of the controller 120 to navigate the path of the pipeline 10 and/or negotiate obstacles or imperfections of the pipeline 10.

Upon encountering a turn, such as an elbow turn in the pipeline 10, the controller 120 can utilize various parameters (e.g. pipe OD, elbow turning ratio, target speed, etc.) to provide speed commands and/or adjust the rotation of the wheels of the pipeline inspection device 100. In some embodiments, the control signals for balancing and turning the pipeline inspection device 100 can be linearly overlaid, allowing the pipeline inspection device 100 to simultaneously turn and remain balanced on the pipeline 10. As described herein, the operational parameters of the pipeline inspection device 100 can be set via a graphical user interface. In some embodiments, the graphical user interface can be used to provide override commands.

Upon encountering an obstacle, the controller 120 can direct the pipeline inspection device 100 to tilt toward one side of the pipeline 10 and utilize feedback signals from the IMUs 150 to calculate and provide speed commands and/or adjust the rotation of the wheels of the pipeline inspection device 100 to balance the pipeline inspection device 100. Signals from the IMUs 150 can include, but are not limited to the magnitude of the tilting angle, the duration of the tilting angle, etc.

The controller 120 may prioritize commands from the operator and/or various safety sub-routines. Further, the controller 120 can adjust the operation of the pipeline inspection device 100 based on outside interference or changes in parameters, including wheel slip, wind, uneven pipe surfaces, etc.

During operation, the controller 120 can operate the motors 140 at different speeds to allow the pipeline inspection device 100 to negotiate pipe shapes or bends. For example, the motors 140 of the left side of the pipeline inspection device 100 can be rotated or accelerated at a faster rate than the motors 140 of the right side of the pipeline inspection device 100, allowing the pipeline inspection device 100 to follow a pipeline 10 that turns toward the right. Each wheel 130 or axle unit can be independently controlled. In another example, the motors 140 of the front axle can be rotated or accelerated at a different rate than the motors 140 of the rear axle of the pipeline inspection device 100, allowing the pipeline inspection device 100 to negotiate changes in inclination (z-axis) of the pipeline 10.

Advantageously, by allowing for different wheel speeds and/or directions for each of the wheels 130 of the pipeline inspection device 100, the pipeline inspection device 100 can navigate and inspect complex pipeline layouts or paths with minimal human intervention.

Further, the configuration or programming of the controller 120 can allow for the pipeline inspection device 100 to self-balance or self-align on an upper portion or top of the pipeline 10. In the depicted example, the controller 120 can utilize feedback from the IMUs 150 to determine the tilt of the pipeline inspection device 100 relative to the pipeline 10 and operate one or more motors 140 to maintain and/or re-align the pipeline inspection device 100 at the top of the pipe azimuth position P. In some embodiments, the sensitivity of the controller 120 in response to feedback from the IMU's 150 can be adjusted for varying pipeline diameters, pipeline conditions, and straight and/or curved (e.g., elbows) pipelines 10.

The controller 120 can monitor signals or feedback from the IMUs 150 to determine if the pipeline inspection device 100 has departed from a determined tilt range T. In some embodiments, the tilt range T can be +/−15 degrees from a center line of the vertical plane. As can be appreciated, the tilt range T can be predefined, varied, or adjusted for varying curvature planes, pipeline conditions, and inspection parameters. In some embodiments, the controller 120 and/or the pipeline inspection device 100 can be configured to travel along the pipeline 10 at an offset angle relative to the top of the pipe.

In response to a determination that the pipeline inspection device 100 has exceeded the determined tilt range T, the controller 120 can operate one or more motors 140 to reposition the pipeline inspection device 100. For example, if the pipeline inspection device 100 has tilted too far toward the left side of the pipe, the controller 120 can operate the left side motors 140 while deactivating the right side motors 140, allowing the pipeline inspection device 100 to be realigned toward the top of the pipeline.

In some applications, in response to a determination that the pipeline inspection device 100 has exceeded the determined tilt range T, the operation of the pipeline inspection device 100 can be disabled to avoid damage to the pipeline inspection device 100. As can be appreciated, the “fail-safe” tilt range T can be varied or adjusted for pipeline conditions and inspection parameters.

Further, the controller 120 can utilize pitch or inclination data from the IMUs 150 to control the ascending and/or descending movement of the front and rear wheels 130 of the pipeline inspection device 100. Advantageously, the controller 120 can utilize the inclination data to control the operation of the pipeline inspection device 100 over elevation changes of the pipeline.

During operation, the controller 120 can utilize self-learning or machine learning routines to optimize the operation of the pipeline inspection device 100 for various pipeline conditions. For example, the controller 120 can self-learn or adapt to allow the pipeline inspection device 100 to remain in a determined tilt range with minimal deviation from the top azimuth of the pipeline.

Advantageously, the independent control of the wheels 130 via the controller 120 allows for high levels of autonomous operation of the pipeline inspection device 100 without human intervention or interruption.

The controller 120 can collect and record operational data regarding the pipeline inspection device 100. For example, the controller 120 may collect and record the rotational speed of each of the wheels 130, the tilt angle of the pipeline inspection device 100, the crawling direction, encoded distance traveled, and/or commands received from the operator. As described herein, operational data may be overlaid with imaging or inspection data captured by the pipeline inspection device 100.

Optionally, the controller 120 can monitor or inspect the distribution of power within the pipeline inspection device 100. For example, the controller 120 can monitor the state of charge of the onboard battery 160 and/or the power usage of the components of the pipeline inspection device 100. In some embodiments, the controller 120 can provide a warning to the operator if the state of charge of the battery 160 is below a desired level and/or the power usage of the components of the pipeline inspection device 100 exceeds a specified threshold.

In some embodiments, the controller software is integrated with other functions of the pipeline inspection device 100. Optionally, the programming of the controller 120 and or the pipeline inspection device 100 can be updated remotely or via a network.

In the depicted example, the pipeline inspection device 100 includes one or more imaging devices 110 to allow for non-destructive inspection of the pipeline 10 as the pipeline inspection device 100 is advanced. In some embodiments, the imaging device 110 can be an x-ray device, or other suitable device.

The imaging devices 110 can provide an imaging signal to an image processor 20 associated with the pipeline inspection device 100. In some embodiments, the image processor 20 can be disposed at a location remote to the pipeline inspection device 100. The image processor 20 can be configured to automatically adjust and/or calibrate to process image signals from the imaging device 110 to provide detailed imaging of thin walled pipe, thick walled pipe, heavy walled pipe, pipe under insulation (wet or dry), and pipe filled with static or dynamic fluids, such as oil, gas, and/or water (including three phase product and flow undergoing slugging). Various calibration techniques can be utilized based on operating conditions and requirements. Advantageously, the imaging device 110 and the image processor 20 can provide images with sufficient levels of detail to allow the operator to determine if the pipeline is damaged (e.g., corrosion) and/or if the pipeline requires repair.

Optionally, the image processor 20 can process image signals to detect and analyze pipeline damage D (e.g., corrosion) and/or determine the remaining wall thickness W of the pipeline 10 wall. In some applications, the image processor 20 can process image signals to detect pipeline damage D, such as corrosion, to infer the loss of wall thickness W on the outside of the pipe. The image processor 20 may identify or recognize defects by measuring the differential or attenuation of radiation transmission through the pipeline 10 material. For example, the inspection device 100 may utilize automated tangential radiography (ATRT) to tangentially image between the insulation and the pipe wall to detect and analyze pipeline damage D and infer the loss of wall thickness W. Advantageously, ATRT can be used to identify pipeline damage D internal to the pipeline 10, external to the pipeline 10, and/or to identify water under insulation of the pipeline 10.

Further, the image processor 20 can process image signals to detect the location of water within insulation material covering the outside of the pipeline. The image processor 20 may further identify areas of the pipeline 10 that require repair. In some embodiments, the image processor 20 can provide analysis of pipeline damage D automatically and/or with minimal human intervention.

For example, the image processor 20 can identify a reduction in wall thickness W by locating, identifying, and measuring neighboring pixels provided by the imaging device 110. In some embodiments, the image processor 20 can allow for real time radiography (RTR) techniques to be utilized. The image processor 20 may be able to automatically identify a reduction in wall thickness W by locating, identifying, and measuring differences in wall thickness within an imaging area or region of interest defined by a plurality of pixels (e.g., an imaging area of 25 pixels or less). In some embodiments, the image processor 20 may be able to identify a reduction in wall thickness W by locating, identifying, and measuring differences in wall thickness in a smaller region of interest, for example region of interest of 9 pixels or less.

For example, the image processor 20 can compare the relative brightness/darkness (gray level) of neighboring pixels to determine areas with reduced wall thickness. The image processor 20 can identify a reduction in wall thickness W across the image by analyzing multiple regions of interest of the image. In some embodiments, the regions of interest may overlap.

During operation, data from the image processor 20 can be recorded for logging and/or review by an operator. In some embodiments, the data from the image processor 20 can be transmitted to an operator for real-time observation. Data can be recorded and/or transmitted in a wide range of formats (e.g., TIFF and/or DICONDE standard formats). In some embodiments, the data can be reformatted or adjusted to provide images in a desired image size, multiple images merged and/or spliced together in sequence. Optionally, the data can be dynamically filtered and/or overlaid with additional data, such as distance travelled data or other capture parameters.

In some embodiments, the pipeline inspection device 100 and/or the imaging devices 110 can be remotely operated by an operator. In some embodiments, the pipeline inspection device 100 operates autonomously, with minimal to no human intervention. Optionally, an operator can control certain aspects of operation of the pipeline inspection device 100 and/or the imaging device 110 while other aspects of operation are autonomously controlled by the pipeline inspection device 100.

The pipeline inspection device 100 can be tethered to a remote control device 30 via a cable or wirelessly connected to a remote control device. In some embodiments, if a tethered or wireless communication link is broken or compromised, the motors 140 of the pipeline inspection device 100 may be stopped. Further, power to an onboard air compressor 170 and/or other components of the pipeline inspection device 100 can be interrupted.

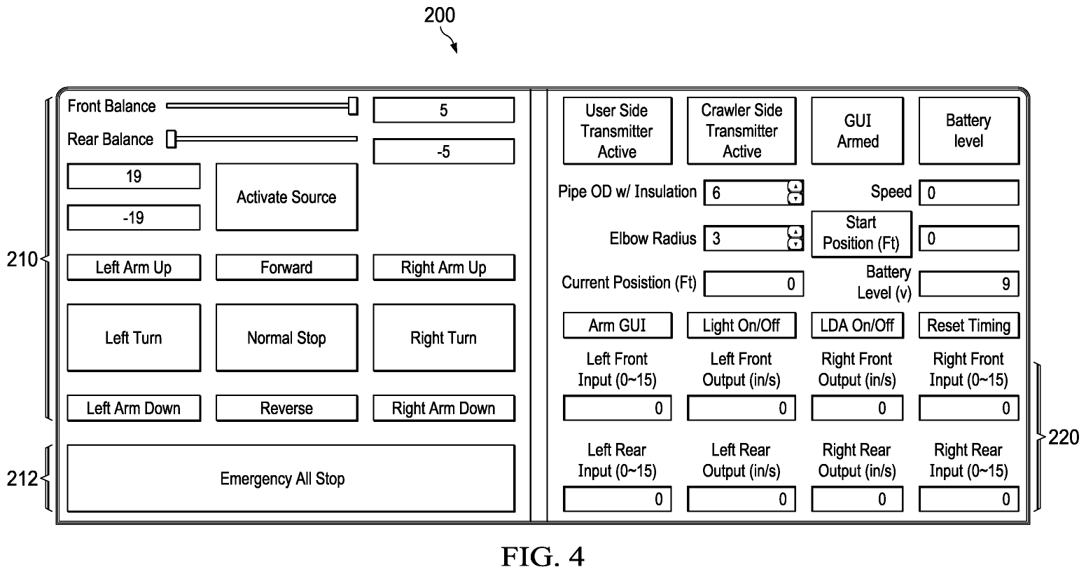

Optionally, the remote operation can be integrated into an inspection software program executed on a remote computing device or remote control device 30. FIG. 4 illustrates a graphical user interface 200 for use with the pipeline inspection device 100 according to certain aspects of the present disclosure. With reference to FIG. 4, an operator can interact with the pipeline inspection device 100 via a graphical user interface 200 displayed by the remote control device 30. The graphical user interface 200 allows the operator to provide inputs or commands 210 to the controller 120 of the pipeline inspection device 100 and receive data from the controller 120 of the pipeline inspection device 100.

For example, the graphical user interface can receive commands 210 from the operator and provide these inputs to the controller 120 of the pipeline inspection device 100. Further, the graphical user interface can receive and process override interrupt and/or emergency stop commands 212.

The graphical user interface 200 can further provide feedback or signals to the operator. For example, the graphical user interface can provide feedback regarding the operating parameters 220 of the pipeline inspection device 100. In some embodiments, the graphical user interface can provide a signal or alert if critical parameters deviate from a nominal value (e.g. low battery state of charge) or if communication between the remote control device 30 and the pipeline inspection device 100 is terminated or otherwise compromised.

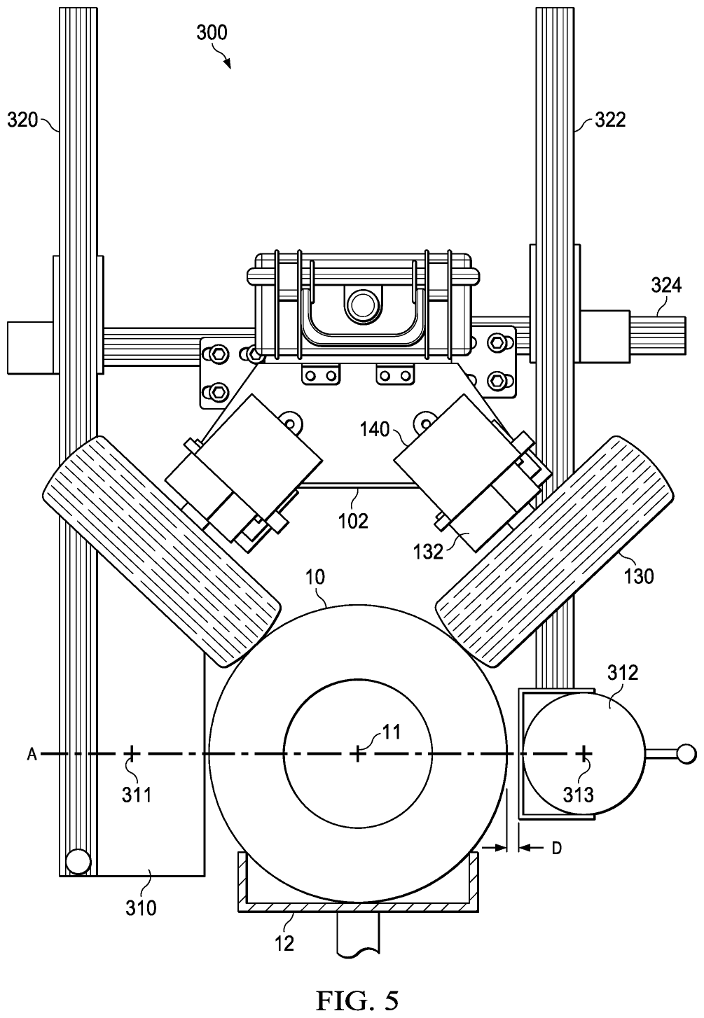

FIG. 5 illustrates a front elevation view of a pipeline inspection device 300 according to certain aspects of the present disclosure. In the depicted example, the pipeline inspection device 300 includes an imaging device 310 to allow for non-destructive inspection of the pipeline 10 as the pipeline inspection device 300 is advanced. Advantageously, the pipeline inspection device 300 and the imaging device 310 allows for high quality imaging of the pipeline 10. In some embodiments, the pipeline inspection device 300 can include features that are similar to features of pipeline inspection device 100. Accordingly, similar features may be referred to with similar reference numerals.

In some embodiments, the imaging device 310 can acquire a high quality image of the pipeline 10 as the pipeline inspection device 300. The imaging device 310 can be any suitable device. In some embodiments, the imaging device 310 can be a linear array imaging device. Advantageously, certain imaging devices 310, such as the linear array imaging device, can allow for high or enhanced quality imaging compared to other certain imaging devices.

In some applications, certain imaging devices 310 can provide 10% or less image deviation, compared to conventional imaging devices, which may provide 20% or greater image deviation. In some embodiments, imaging devices 310 can provide 5% or less image deviation. Further, certain imaging devices 310 can provide 10% or less image deviation in a single pass of the pipeline 10, while conventional imaging devices may provide 20% or greater image deviation while requiring multiple passes of the pipeline 10. In some embodiments, imaging devices 310 can provide 5% or less image deviation in a single pass of the pipeline 10.

In some applications, the lower image deviation provided by certain imaging devices 310 can allow for sufficient image quality to identify pipeline defects, pipeline damage, and pipeline remaining wall thickness without requiring multiple passes of the pipeline inspection device across the pipeline 10. Further, the lower image deviation provided by certain imaging devices 310 can allow for sufficient image quality to be captured with a single imaging device 310. Advantageously, by utilizing an imaging device 310 that provides a high or enhanced quality image, the pipeline inspection device 300 can carry a single imaging device 310 instead of multiple imaging devices.

As illustrated, the pipeline inspection device 300 can include a radiation device 312 to work in conjunction with the imaging device 310 to allow for non-destructive inspection of the pipeline 10 as the pipeline inspection device 300 is advanced. In the depicted example, the radiation device 312 can emit, transmit, or otherwise provide radiation to the imaging device 310 through the pipeline 10, allowing the imaging device 310 to image the pipeline 10. In some embodiments, the radiation device 312 can be a high-power radiation source, such as a gamma exposure device.

In some applications, the radiation device 312 can emit sufficient radiation to allow for imaging through the pipeline 10. Advantageously, the radiation device 312 can emit sufficient radiation to allow for imaging devices to provide 5% or less image deviation. Further, the radiation device 312 can emit sufficient radiation to allow for imaging devices to provide 5% or less image deviation in a single pass of the pipeline 10.

In some applications, the lower image deviation provided by certain imaging devices 310 and radiation device 312 can allow for sufficient image quality to identify pipeline defects, pipeline damage, and pipeline remaining wall thickness without requiring multiple passes of the pipeline inspection device 300 across the pipeline 10. Further, the lower image deviation provided by certain radiation devices 312 can allow for sufficient image quality to be captured with a single imaging device 310 and single radiation device 312. Advantageously, by utilizing high powered radiation device 312, the pipeline inspection device 300 can carry a single radiation device 312 instead of multiple radiation devices 312.

As illustrated, the imaging device 310 and the radiation device 312 can be coupled to or otherwise attached to the device housing 102 of the pipeline inspection device 300. In the depicted example, the imaging device 310 is coupled to the device housing 102 via an imaging device rail 320. In some embodiments, the imaging device rail 320 is coupled to the device housing 102 at a first end and extends below the device housing 102 and wheels 130 toward the pipeline 10. The imaging device 310 is coupled at or near a second end of the imaging device rail 320 and is vertically offset relative to the device housing 102. In some embodiments, the imaging device 310 is movable along the imaging device rail 320. Optionally, an actuator can move the imaging device 310 relative to the imaging device rail 320.

Similarly, the radiation device 312 can be coupled to the device housing 102 via an radiation device rail 322. In some embodiments, the radiation device rail 322 is coupled to the device housing 102 at a first end and extends below the device housing 102 and wheels 130 toward the pipeline 10. The radiation device 312 is coupled at or near a second end of the radiation device rail 322 and is vertically offset relative to the device housing 102. In some embodiments, the radiation device 312 is movable along the radiation device rail 322. Optionally, an actuator can move the radiation device 312 relative to the radiation device rail 322.

Optionally, the imaging device 310 and/or the radiation device 312 is laterally offset relative to the device housing 102. In some embodiments, the imaging device rail 320 and/or the radiation device rail 322 are coupled to the device housing 102 via a cross bar 324. The cross bar 324 is coupled to the device housing 102 and extends laterally in either direction. As illustrated, the imaging device rail 320 can couple to a first end of the cross bar 324 and the radiation device rail 322 can couple to an opposite second end of the cross bar 324, laterally offsetting the imaging device 310 and/or the radiation device 312 relative to the device housing 102. In some embodiments, the imaging device rail 320 and/or the radiation device rail 322 are movable along the cross bar 324. Optionally, an actuator can move the imaging device rail 320 and/or the radiation device rail 322 relative to the cross bar 324.

In the depicted example, the imaging device 310 and the radiation device 312 can be arranged relative to the pipeline 10 via the imaging device rail 320, the radiation device rail 322, and/or the cross bar 324 to allow for high quality imaging of the pipeline 10. As illustrated, the imaging device 310 and/or the radiation device 312 can be disposed adjacent to the pipeline 10. In some embodiments, the imaging device 310 and/or the radiation device 312 can be disposed in close proximity to the pipeline 10. For example, the radiation device 312 can be disposed a distance D from the surface of the pipeline 10, wherein distance D provide enhanced or improved imaging via the imaging device 310.

The imaging device 310 and the radiation device 312 can be disposed at any suitable angular orientation relative to the pipeline 10. For example, when viewing a lateral cross-section of the pipeline 10, as shown in FIG. 5, the imaging device 310 can be disposed at 0 degrees, 45 degrees, 90 degrees, 120 degrees, 135 degrees, 180 degrees, 225 degrees, 270 degrees, 315 degrees, etc. Similarly, the radiation device 312 can be disposed at 0 degrees, 45 degrees, 90 degrees, 120 degrees, 135 degrees, 180 degrees, 225 degrees, 270 degrees, 315 degrees, etc. In some embodiments, the imaging device 310 and the radiation device 312 can be disposed opposite to each other on opposite sides of the pipeline 10 to allow imaging through the pipeline 10. Accordingly, the radiation device 312 can be disposed 180 degrees opposite to the imaging device 310 relative to the pipeline 10.

In some applications, the imaging device 310 and/or the radiation device 312 can be centered relative to the pipeline 10. For example, an imaging device center 311 of the imaging device 310 can be aligned with a central axis 11 of the pipeline 10. The imaging device center 311 can be a geometric center point of the imaging device 310, an imaging axis of the imaging device 310 or any other point of interest of the imaging device 310. Similarly, a radiation device center 313 of the radiation device 312 can be aligned with the central axis of the pipeline 10. The radiation device center 313 can be a geometric center point of the radiation device 312 or any other point of interest of the radiation device 312. In some embodiments, the imaging device center 311, the central axis 11, and the radiation device center 313 can be aligned along a common axis A. Advantageously, by disposing the imaging device center 311 and the radiation device center 313 along a common axis with the central axis 11 of the pipeline 10, the pipeline inspection device 300 can obtain high quality images as described herein without requiring multiple passes or multiple imaging devices. In contrast, in certain conventional applications, conventional imaging devices and conventional radiation devices disposed along a common axis with the central axis of the pipeline may not be able to pass signals through the pipeline to produce images of sufficient quality to identify defects or determine wall thicknesses. In certain conventional applications, conventional imaging devices and conventional radiation devices are typically disposed offset from the central axis to address the technological shortcomings of those conventional devices. Optionally, the imaging device center 311 and the radiation device center 313 can be aligned while being offset from the central axis 11.

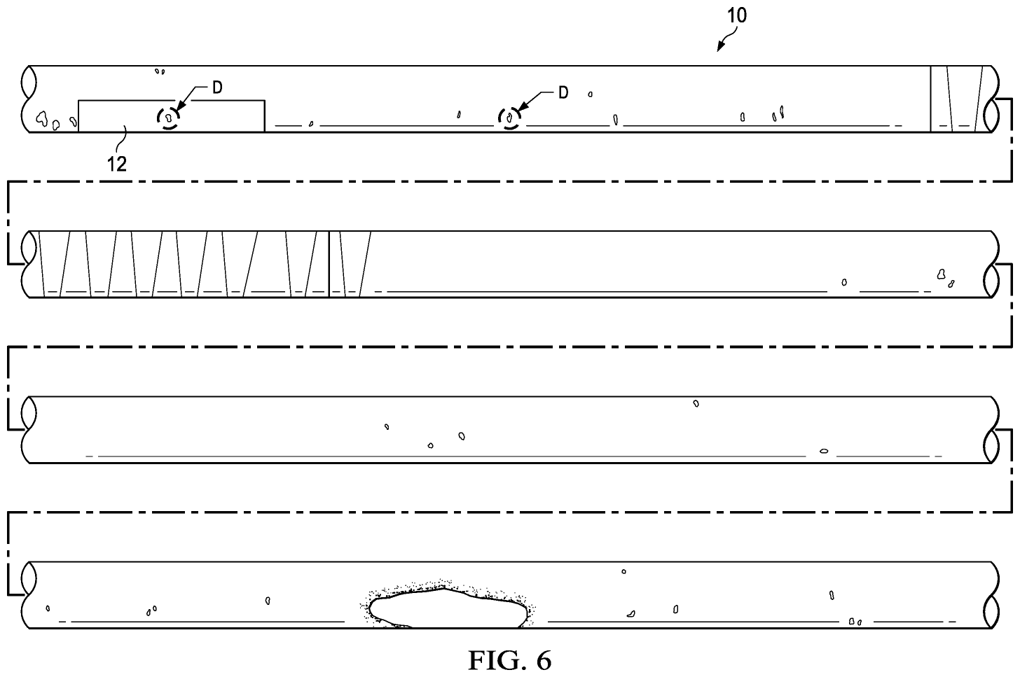

FIG. 6 illustrates an example of a pipeline image captured by the pipeline inspection device 300. With reference to FIGS. 5 and 6, the pipeline inspection device 300 allows for enhanced image quality while using a single imaging device 310 over a single pass of the pipeline 10. The resulting image includes sufficient detail (e.g. 5% or less image deviation) to allow defects and wall thickness to be analyzed and determined. As illustrated, defects D can be identified within the pipeline 10. In some embodiments, an image processor 20 can be used to process images from the imaging device 310 to identify defects D. Optionally, the pipeline image can include a location overlay to provide context for the image.

In some applications, the imaging device 310 and/or the radiation device 312 can be positioned to allow a portion of the pipeline 10 supported by a saddle 12 to be non-destructively inspected. As illustrated, the imaging device 310 and/or the radiation device 312 can be positioned to avoid contact with the saddle 12, allowing the pipeline inspection device 300 to operate or travel across the saddles 12 of the pipeline 10 without disrupting operation of the pipeline inspection device 300.

As shown in FIG. 6, in some embodiments, the imaging device 310 can be utilized to provide image data regarding the saddle 12 and portions of the pipeline 10 supported by the saddle 12. Advantageously, the pipeline inspection device 300 can identify defects D within the saddle 12 and/or portions of the pipeline 10 supported by the saddle 12. In contrast, certain conventional pipeline inspection devices stop operation upon encountering a saddle 12 or otherwise omit inspection of the saddle 12 and/or portions of the pipeline 10 supported by the saddle 12.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A device to inspect a pipeline comprising a central longitudinal axis, the device comprising:
a device housing moveable relative to the pipeline;
a radiation device coupled to the device housing and disposed adjacent to the pipeline; and
an imaging device coupled to the device housing and disposed adjacent to the pipeline, wherein the imaging device may be disposed opposite to the radiation device relative to the central longitudinal axis of the pipeline, and the imaging device receives radiation from the radiation device to provide an imaging signal.

2. The device of claim 1, wherein the radiation device and the imaging device are each disposed laterally adjacent to the pipeline.

3. The device of claim 1, wherein the radiation device and the imaging device are each disposed below the device housing.

4. The device of claim 1, wherein a center of the radiation device, a center of the imaging device, and a center of the pipeline are disposed in a common plane.

5. The device of claim 1, wherein the radiation device is spaced apart a desired distance from the pipeline.

6. The device of claim 1, further comprising a radiation device rail coupled to the device housing and coupled to the radiation device.

7. The device of claim 6, wherein the radiation device is movable relative to the radiation device rail.

8. The device of claim 6, further comprising an imaging device rail coupled to the device housing and coupled to the imaging device.

9. The device of claim 8, wherein the imaging device is movable relative to the imaging device rail.

10. The device of claim 8, further comprising a cross bar coupled to the device housing, wherein the radiation device rail and the imaging device rail extend from the cross bar.

11. The device of claim 10, wherein the radiation device rail and the imaging device rail are movable relative to the cross bar.

12. A device to inspect a pipeline, the device comprising:
a device housing movable relative to the pipeline; and
a single imaging device coupled to the device housing and disposed adjacent to the pipeline, wherein the imaging device is configured to provide an imaging signal.

13. The device of claim 12, wherein the single imaging device comprises a linear array imaging sensor.

14. The device of claim 12, further comprising a radiation device coupled to the device housing and disposed adjacent to the pipeline, wherein the radiation device is disposed opposite to the imaging device relative to the pipeline, and the imaging device receives radiation from the radiation device to provide the imaging signal.

15. The device of claim 14, wherein the radiation device comprises a gamma radiation device.

16. A method to inspect a pipeline, the method comprising:
advancing a pipeline inspection device along the pipeline during a first pass;
obtaining an imaging signal from a single imaging device during the first pass; and
identifying a defect of the pipeline based on the imaging signal from the single imaging device during the first pass.

17. The method of claim 16, further comprising advancing the pipeline inspection device across a saddle of the pipeline.

18. The method of claim 17, further comprising advancing the single imaging device across the saddle of the pipeline.

19. The method of claim 18, further comprising identifying a saddle defect of the saddle based on the imaging signal from the single imaging device during the first pass.
